(19) United States
(12) Patent Application Publication
(10) Pub. No.: US 2026/0218987 A1
(43) Pub. Date: Jul. 30, 2026

(54) METHOD FOR ASSEMBLING A HEAT EXCHANGER WITH COAXIAL TUBING FOR AN AIR-CONDITIONING CIRCUIT OF A VEHICLE

(71) Applicant: HUTCHINSON, Clichy (FR)

(72) Inventor: Bérenger DIEUMEGARD, AMILLY (FR)

(21) Appl. No.: 19/462,779

(22) Filed: Jan. 28, 2026

(30) Foreign Application Priority Data
Jan. 30, 2025 (FR) 2500793

(51) Int. Cl. F28D 7/10; B60H 1/00; F28D 7/14; F28F 9/02

(52) U.S. Cl. CPC F28D 7/106; B60H 1/00321; F28D 7/14; F28F 9/0251; F28F 2275/025; F28F 2275/04; F28F 2275/06

(57) ABSTRACT

Disclosed is a method for assembling a heat exchanger with coaxial tubing, in particular for an air-conditioning circuit of a vehicle. The exchanger comprising a coaxial tubing comprises two coaxial tubes, a first fluid connector formed by a first block located at a first longitudinal end of the tubing, a second fluid connector formed by a second block located at a second longitudinal end of the tubing, and opposite the first longitudinal end. The internal tube is formed in a single piece and the external tube is formed by two consecutive sections.

### CROSS REFERENCE TO RELATED APPLICATION

This present application claims priority to French Patent Application No. FR2500973, filed January 30, 2025, the disclosure of which is hereby incorporated by reference in its entirety.

### TECHNICAL FIELD

This disclosure relates to a method for assembling a heat exchanger with coaxial tubing, in particular for an air-conditioning circuit of a vehicle, and to a heat exchanger of this type.

### BACKGROUND

In certain air conditioning circuits for motor vehicles, in particular those using carbon dioxide or R134a or 1234yf as a refrigerant, it is necessary to carry out a heat exchange or transfer between the fluid in the high-pressure portion of the circuit that is being cooled and the same fluid from the low-pressure portion of this circuit, which acts as a cold source and is heated in exchange, in order to improve the efficiency of the circuit. An "internal" heat exchanger is used for this purpose, as it does not seek exchanges with the air outside the vehicle or with the air in the passenger compartment.

In general, a heat exchanger is metallic and is connected to the corresponding pipes of the air-conditioning circuit, which in particular comprise flexible hoses, via connectors mounted at each end of the exchanger, which may be, for example, of the plate type, consisting of a stack of flat tubes and carrying out heat exchange both by convection with the air outside the exchanger and by conduction, or of the multi-tube type which in its simplest version is of the coaxial tubular counter-current type, then carrying out heat exchange without the aforementioned convection.

In the latter case, this coaxial exchanger generally defines at least one radially internal channel delimited by an internal tube and configured to convey the fluid coming from the high-pressure portion of the circuit, and at least one radially external channel located between the internal tube and an external tube of the exchanger and configured to convey the fluid coming from the low-pressure portion of the circuit. The internal and external tubes are coaxial and separated from each other by longitudinal fins distributed around the circumference of the exchanger.

Connectors have been known to be fixed to the longitudinal ends of the exchanger by welding or brazing.

A major disadvantage lies in the mutual proximity of the soldering or brazing lines generated which, particularly for successive brazing operations, generate risks of reflow of the previous brazing material, and also in the need to carry out these soldering or brazing operations blindly, with risks of non-tightness at the junction and/or penetration of the brazing material into the corresponding internal or external channel, which can lead to pressure losses, pollution or even clogging of these channels.

In the document EP-A1-1 762 806, a connector is assembled by brazing via an intermediate fitting, and in the document EP-A1-1 128 120 (FIGS. 10 et seq.) a connector is brazed directly to the exchanger tubes via two brazing beads.

However, these solutions are not optimal, in particular because assembling the exchanger requires at least two brazing operations to be carried out at the same time, at least one of which, relating to the junction to be made between the connector and the internal tube, is necessarily carried out "blind" or under difficult conditions due to its location inside the connector. As a result, there is a significant risk of non-compliance of the connection and therefore leakage of the fluid being transferred. In addition, these brazings involve a relatively high manufacturing cost and disposal rate for the resulting connection.

The Applicant has proposed a solution in the document EP-A1-2 199 721. This solution consists of assembling the connector to the external tube by welding, and to the internal tube by at least one annular sealing gasket which is mounted on an axial extension of the internal tube with respect to the external tube. The axial distance between the seal and the weld line is large enough to ensure that the seal is not affected by the welding process. As the exchanger is a single piece, the tubes are inseparable and are therefore fitted simultaneously in the connector.

Although this solution is effective, it is not entirely satisfactory because the axial extension of the sleeve means that the exchanger and connector take up a lot of space.

n the document EP-A1-3 848 660, the applicant proposed a sealed connection method in which the exchanger tubes are independent and are fitted one after the other in the connector.

The present disclosure provides an improvement to this type of method, which is particularly suitable for making an exchanger comprising a connector at each of its longitudinal ends.

### SUMMARY

The present disclosure provides a method for assembling a heat exchanger with coaxial tubing, in particular for an air-conditioning circuit of a vehicle, the exchanger comprising:

a coaxial tubing comprising two coaxial tubes, an internal tube and an external tube respectively, the external tube defining, around the internal tube, a first annular channel for the circulation of a first fluid, and the internal tube internally defining a second channel for the circulation of a second fluid, the tubes being independent and one of the tubes comprising projections bearing on the other of the tubes in order to keep them at a distance from one another,

a first fluid connector formed by a first block located at a first longitudinal end of the tubing, the first block comprising a first housing for receiving a first longitudinal end of the external tube and a first port in fluid communication with said first housing, the first block comprising a second housing, coaxial with the first housing, for receiving a first longitudinal end of the internal tube and a second port in fluid communication with said second port,

a second fluid connector formed by a second block located at a second longitudinal end of the tubing, opposite the first longitudinal end, the second block comprising a first housing for receiving a second longitudinal end of the external tube, and a first port in fluid communication with said first housing, the second block comprising a second housing, coaxial with the first housing, for receiving a second longitudinal end of the internal tube and a second port in fluid communication with said second port,

characterised in that, the internal tube is formed from a single piece and the external tube is formed by two consecutive sections, the method comprises the following successive steps:

a) the first longitudinal end of the external tube is engaged in the first housing of the first block and this first longitudinal end is fixed to the first block, this first longitudinal end being located on a first of the sections of the external tube, and the second longitudinal end of the external tube is engaged in the first housing of the second block and this second longitudinal end is fixed to the second block, this second longitudinal end being located on a second of the sections of the external tube,

b) the internal tube is engaged in the first section, from a free longitudinal end of this first section, opposite the first block, then the internal tube is slid in the first section until the first longitudinal end of the internal tube engages in the second housing of the first block,

c) the internal tube is engaged in the second section, from a free longitudinal end of this second section, opposite the second block, then the internal tube is slid in the second section until the second longitudinal end of the internal tube engages in the second housing of the second block, and

d) the first and second sections of the external tube are secured to each other by means of their respective free longitudinal ends.

The present disclosure thus proposes a new method for assembling an exchanger of the above-mentioned type which has the particularity of having an external tube in two sections, these two sections being fixed to each other at the end of the method so that this operation is carried out remotely from the connectors. Any seals or gaskets located in the connectors are therefore not likely to be altered by this external tube fixing operation.

The method according to the disclosure may comprise one or more of the following steps or characteristics, taken in isolation from one another or in combination with one another:

in step d), the first and second sections of the external tube are secured to each other by means of a connection sleeve which connects their respective free longitudinal ends;

the connection sleeve is mounted on the free longitudinal end of the first section, before step a), or before step b);

the connection sleeve is mounted on the free longitudinal end of the second section, before step a), or before step b), or before step c);

the connection sleeve is fixed to the free longitudinal ends of the first and second sections by brazing, welding or gluing;

in step d), the first and second sections of the external tube are secured to each other by welding, brazing or direct bonding of these sections;

in step d), the first and second sections of the external tube are secured to each other by deforming the free longitudinal end of one of the sections to form a female part, or respectively a male part, by inserting the free longitudinal end of the other of the sections by male-female engagement on or in the deformed free longitudinal end, and by welding, brazing or gluing these free ends;

the first and second longitudinal ends of the external tube are fixed to the first and second blocks respectively by welding, brazing or gluing;

the first and second longitudinal ends of the external tube are not fixed to the first and second blocks respectively by welding, brazing or gluing;

a first tubular end piece carrying at least one annular seal is located at the first longitudinal end of the internal tube, said at least one gasket being configured to cooperate with said second housing of the first block to provide a seal, and a second tubular end piece carrying at least one annular gasket is located at the second longitudinal end of the internal tube, said at least one gasket being configured to cooperate with said second housing of the second block to provide a seal;

each of the first and second tubular end pieces is mounted on or in the corresponding longitudinal end, and fixed to that end by welding, brazing or gluing;

each of the first and second tubular end pieces is formed directly on the corresponding longitudinal end, and is therefore formed in one piece with the internal tube;

the first and second end pieces each carry two annular sealing gaskets;

at least one of the ports of the first block is oriented perpendicular to an axis of elongation of the tubing, and at least one of the ports of the second block is oriented perpendicular to the axis of elongation of the tubing;

the method comprises, after step d), a step e) of shaping the tubing by bending and plastic deformation of this tubing;

the first and second blocks each have a generally parallelepiped shape;

the ports of each of the blocks open onto one and the same flat face of the block, or onto two flat faces of the block which are perpendicular to each other;

the tubes are made of the same or different materials;

the tubes are made of metal alloy(s) or plastic material(s);

the connectors are made of the same or different materials;

the connectors are made of metal alloy(s) or plastic material(s).

The present disclosure also relates to a heat exchanger with coaxial tubing, in particular for an air-conditioning circuit of a vehicle, this exchanger being obtained by a method according to one of the preceding claims and comprising:

a coaxial tubing comprising two coaxial tubes, an internal tube and an external tube respectively, the external tube defining, around the internal tube, a first annular channel for the circulation of a first fluid, and the internal tube internally defining a second channel for the circulation of a second fluid, the tubes being independent and one of the tubes comprising projections bearing on the other of the tubes in order to keep them at a distance from one another,

a first fluid connector formed by a first block located at a first longitudinal end of the tubing, the first block comprising a first housing for receiving a first longitudinal end of the external tube and a first port in fluid communication with said first housing, the first block comprising a second housing, coaxial with the first housing, for receiving a first longitudinal end of the internal tube and a second port in fluid communication with said second port,

a second fluid connector formed by a second block located at a second longitudinal end of the tubing, opposite the first longitudinal end, the second block comprising a first housing for receiving a second longitudinal end of the external tube, and a first port in fluid communication with said first housing, the first block comprising a second housing, coaxial with the first housing, for receiving a second longitudinal end of the internal tube and a second port in fluid communication with said second port,

wherein, the internal tube is formed from a single piece and the external tube is formed from two consecutive sections,

wherein the internal tube has its two longitudinal ends mounted respectively in the second housings of the first and second blocks without these longitudinal ends being fixed to the first and second blocks by welding, brazing or gluing,

wherein the external tube has its two longitudinal ends mounted respectively in the first housings of the first and second blocks and fixed by welding, brazing or gluing to the first and second blocks,

and wherein the longitudinal ends of the first and second sections of the external tube, opposite the first and second blocks respectively, are secured to each other, in particular by a connecting sleeve fixed by welding, brazing or gluing to these longitudinal ends of the first and second sections.

### BRIEF DESCRIPTION OF THE FIGURES

Further characteristics and advantages of the disclosure will become apparent from the following detailed description, for the understanding of which reference is made to the attached drawings wherein:

FIG. 1 is a schematic perspective view of a double connector heat exchanger,

FIG. 2 is a schematic cross-sectional view of a double-connector heat exchanger,

FIG. 3 is a schematic perspective view of a first connector of a dual-connector heat exchanger,

FIG. 4 is a schematic perspective view of a second connector of a dual-connector heat exchanger,

FIG. 5 is a schematic perspective view of a coaxial tubing for a dual-connector heat exchanger,

FIG. 6 is a schematic perspective view of the longitudinal end of a coaxial tubing in a connector of a dual-connector heat exchanger,

FIG. 7 is a schematic perspective view of a longitudinal end of a coaxial tubing and a tubular end piece mounted on this end,

FIGS. 8a to 8c are schematic views of a heat exchanger according to the disclosure and show steps in a method for assembling this exchanger, and

FIG. 9 is a schematic perspective view of a heat exchanger according to the disclosure.

### DETAILED DESCRIPTION

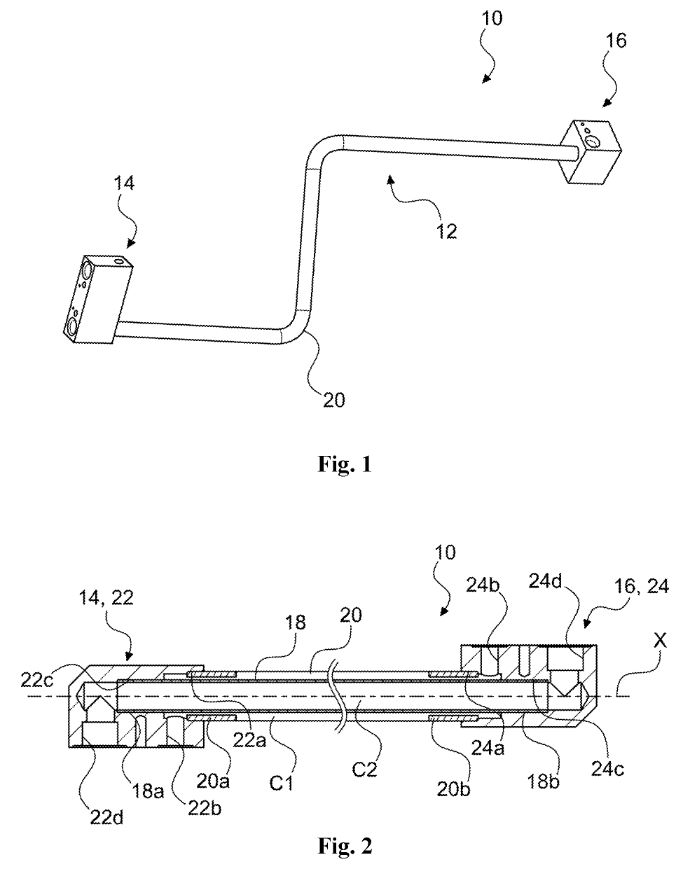

FIGS. 1 to 4 illustrate a heat exchanger 10 with coaxial tubing, in particular for an air-conditioning circuit of a vehicle, for example a motor vehicle.

The exchanger 10 essentially comprises three elements, namely a coaxial tubing 12 and two connectors 14, 16 which are in the form of blocks.

The tubing 12 has a generally elongated shape and comprises two coaxial tubes extending one inside the other. The internal tube is referenced 18 and the external tube is referenced 20.

The external tube 20 defines an annular channel C1 around the internal tube 18 for the circulation of a first fluid, and the internal tube 18 internally defines a second channel C2 for the circulation of a second fluid. To ensure sufficient spacing between tubes 18, 20 and the formation of channel C1, one of the tubes generally comprises projections 21, such as fins, resting on the other of the tubes to keep them at a distance from each other. The fins can extend parallel to the longitudinal axis X of the tubing 12 or helically around this axis. They can be continuous or discontinuous.

In the example shown in FIG. 5, the projections 21 are formed on the internal tube 18. The internal tube 18 thus comprises projections on its external cylindrical surface surrounded by the external tube 20, which rest on an internal cylindrical surface of the external tube 20.

The tubes 18, 20 may be made of the same or different materials. They can be made of metal alloy(s) or plastic material(s), for example.

The connectors 14, 16 may be made of the same or different materials. They can be made of metal alloy(s) or plastic material(s), for example.

The first connector 14 is located at a first longitudinal end 12a of the tubing 12.

The first connector 14 is formed by a first block 22 which comprises a first housing 22a for receiving a first longitudinal end 20a of the external tube 20 and a first port 22b in fluid communication with the first housing 22a.

The first block 22 also comprises a second housing 22c, coaxial with the first housing 22a, for receiving a first longitudinal end 18a of the internal tube 18 and a second port 22d in fluid communication with the second port 22d,

The second connector 16 is formed by a second block 24 which comprises a first housing 24a for receiving a second longitudinal end 20b of the external tube 20 and a first port 24b in fluid communication with the first housing 24a.

The second block 24 also comprises a second housing 24c, coaxial with the first housing 24a, for receiving a second longitudinal end 18b of the internal tube 18 and a second port 24d in fluid communication with the second port 24d.

In FIG. 2, the tubing 12 is straight. In FIG. 1, the tubing 12 has a shape with several bends. The tubing 12 in FIG. 1 has undergone a forming or shaping or bending step, starting from the initial shape in FIG. 2 for example. This shaping can be used to secure the tubes 16, 20 together, particularly in the areas where the tubes are simultaneously bent and plastically deformed by being clamped together.

The exchanger 10 shown in FIG. 1 is ready for installation in an air-conditioning circuit and for use.

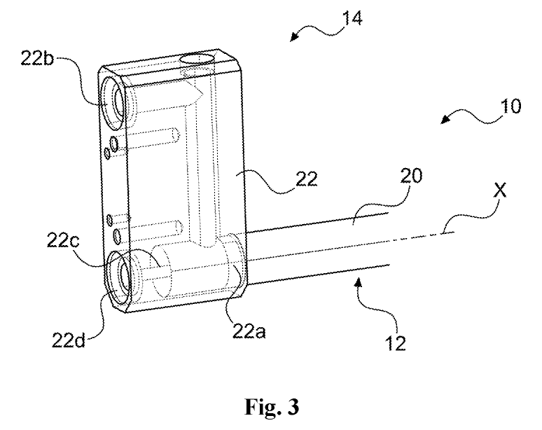

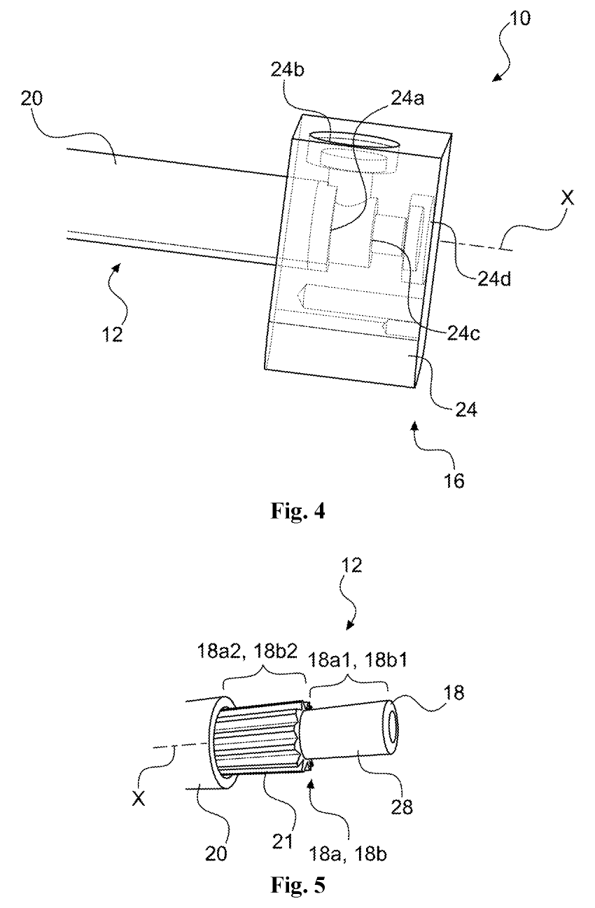

FIGS. 3 and 4 are larger-scale views of the connectors 14 and 16. Although not restrictive, it can be seen in these figures that the ports 22b, 22d of the first block 22 may be parallel to each other and parallel to the axis X of the tubing 12. It can also be seen that the ports 22b, 22d can be located on the same face of the first block 22, which here has a general parallelepiped or parallelepiped-like shape.

It can also be seen in these figures that the ports 24b, 24d of the second block 24 can be perpendicular to each other and can be located on two distinct and perpendicular faces of the second block 24, which here has a generally parallelepipedal or parallelepiped-like shape.

The first port 22b, for example, forms a low-pressure fluid inlet and the second port 22d, for example, forms a high-pressure fluid outlet. The first port 24b, for example, forms a low-pressure fluid outlet and the second port 24d, for example, forms a high-pressure fluid inlet. It is therefore understood that the low and high pressure fluids flow in opposite directions and that the high pressure fluid flows inside the low pressure fluid.

As can be seen in FIG. 5, the external tube 20 preferably has longitudinal ends 20a, 20b which are cut straight (in planes perpendicular to the axis X of the tubing 12). These longitudinal ends 20a, 20b are housed respectively in the housings 22a, 24a of the connectors 14, 16.

The internal tube 18 preferably has longitudinal ends 18a, 18b which are cut straight (in planes perpendicular to the axis X of the tubing 12). These longitudinal ends 18a, 18b are housed respectively in the housings 22c, 24c of the connectors 14, 16.

As illustrated in FIG. 5, the longitudinal ends 18a, 18b of the internal tube 18 preferably extend beyond the cross-sectional plane of the external tube 20 and are preferably partly exposed so as to present a first portion 18a1, 18b1 without projections 21 and a second portion 18a2, 18b2 with projections 21, the second portion 18a2, 18b2 being located axially between the longitudinal end 18a, 18b of the external tube 20 and the first portion 18a1, 18b1.

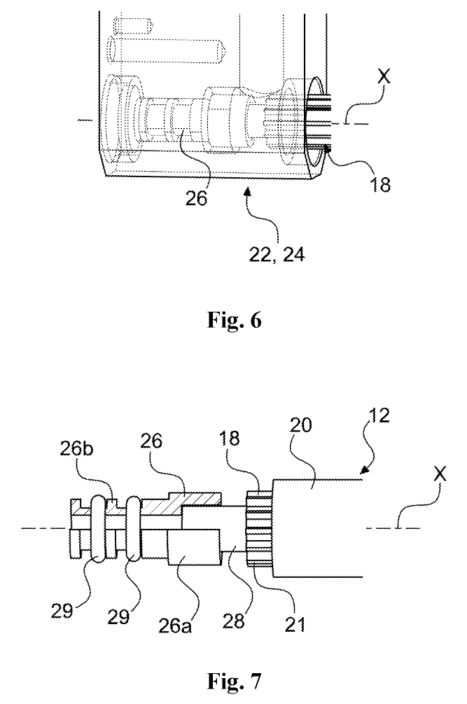

The first portion 18a1, 18b1 may carry at least one annular sealing gasket 29 or may comprise or allow the mounting of a tubular end piece 26 which carries at least one annular sealing gasket 29 (FIGS. 6 and 7).

In the example shown, the first portion 18a1, 18b1 comprises an external cylindrical surface 28 on which the end piece 26 is mounted.

The end piece 26 is engaged by male-female cooperation on the longitudinal end 18a, 18b of the internal tube 18 and in particular on its surface 28. In the example shown, the end piece 26 comprises a female portion 26a mounted on the surface 28, and a portion 26b carrying at least one gasket 29.

There are two gaskets 29 here. They are housed in external annular grooves in the end piece 26, and in particular in the portion 26b. The gaskets 29 are identical, toroidal and axially spaced apart. They can be combined with anti-extrusion rings.

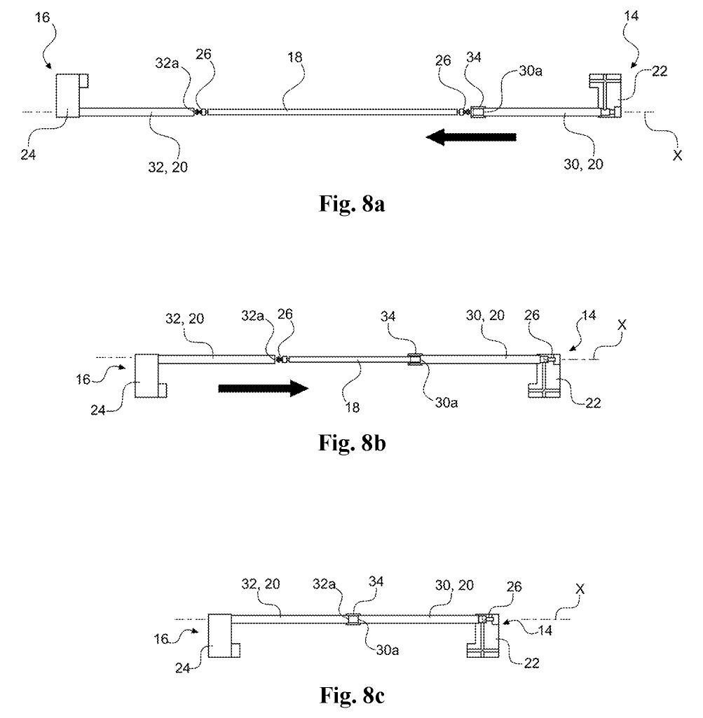

The particularity of the disclosure lies in the fact that the internal tube 18 is formed in a single piece (with or without the aforementioned end pieces 26), as can be seen in FIG. 8a, and that the external tube 20 is formed by two consecutive sections 30, 32, as can be seen in FIGS. 8a to 8c.

The internal tube 18 has its two longitudinal ends 18a, 18b which are preferably mounted respectively in the second housings 22c, 24c of the first and second blocks 22, 24 without these longitudinal ends 18a, 18b being fixed to the first and second blocks 22, 24 by welding, brazing or gluing. For this purpose, the aforementioned end pieces 26 can be used.

The external tube 20 has its two longitudinal ends 20a, 20b which are preferably mounted respectively in the first housings 22a, 24a of the first and second blocks 2, 24 and which are fixed by welding, brazing or gluing to the first and second blocks 22, 24.

The longitudinal ends 30a, 32a of the first and second sections 30, 32 of the external tube 20, opposite the first and second blocks 22, 24 respectively, are secured to each other, for example by a connecting sleeve 34 which is fixed by welding, brazing or gluing to these longitudinal ends 30a, 32a of the first and second sections 30, 32

In a variant not shown, the first and second sections 30, 32 of the external tube 20 could be secured to each other by welding, brazing or direct bonding of these sections. It would then not be necessary to use a sleeve 34.

In an embodiment not shown, the first and second sections 30, 32 of the external tube 20 could be secured to each other by deforming the free longitudinal end of one of the sections to form a female part, or respectively a male part, by inserting the free longitudinal end of the other of the sections by male-female engagement on or in the deformed free longitudinal end, and by welding, brazing or gluing these free ends.

The present disclosure thus proposes a method for assembling an exchanger 10 which comprises the following successive steps:

a) the first longitudinal end 20a of the external tube 20 is engaged in the first housing 22a of the first block 22 and this first longitudinal end 20a is fixed to the first block 22, this first longitudinal end 20a being located on the first section 30 of the external tube 20, and the second longitudinal end 20b of the external tube 20 is engaged in the first housing 24a of the second block 24 and this second longitudinal end 20b is fixed to the second block 24, this second longitudinal end 20b being located on the second section 32 of the external tube 20 (FIG. 8a),

b) the internal tube 18 is engaged in the first section 30, from a free longitudinal end 30a of this first section 30, opposite the first block 22, then the internal tube 18 is made to slide in the first section 30 until the first longitudinal end 18a of the internal tube 18 engages in the second housing 22c of the first block 22 (FIGS. 8a and 8b),

c) the internal tube 18 is engaged in the second section 32, from a free longitudinal end 32a of this second section 32, opposite the second block 24, then the internal tube 18 is slid in the second section 32 until the second longitudinal end 18b of the internal tube 18 engages in the second housing 24c of the second block 24 (FIGS. 8b and 8c), and

d) the first and second sections 30, 32 of the external tube 20 are secured to each other by means of their respective free longitudinal ends 30a, 32a (FIG. 8c).

In step d), the first and second sections 30a, 32 of the external tube 20 are secured to each other by means of the connection sleeve 34 which connects their respective free longitudinal ends 30a, 32a. The sleeve 34 can cooperate by male-female interlocking with the free longitudinal ends 30a, 32a of the first and second sections 30a, 32 respectively.

The sleeve 34 can be mounted on the free longitudinal end 30a of the first section 30, before the step a), or before the step b), as shown in FIGS. 8a and 8b.

Alternatively, the sleeve 34 could be mounted on the free longitudinal end 32a of the second section 32, before step a), or before step b), or before step c).

The sleeve 34 can be fixed to the free longitudinal ends 30a, 32a of the first and second sections 30, 32 by brazing, welding or gluing.

In the other variants mentioned above and not using a sleeve 34, the free longitudinal ends 30a, 32a of the first and second sections 30, 32 could be fixed directly to each other by brazing, welding or gluing, with or without prior deformation of one of these ends in order to be able to fit the ends 30a, 32a into each other by male-female engagement.

The first and second longitudinal ends 20a, 20b of the external tube 20 are preferably fixed to the first and second blocks 22, 24 respectively by welding, brazing or gluing.

The first and second longitudinal ends 18a, 18b of the internal tube 18 are preferably not fixed to the first and second blocks respectively by welding, brazing or gluing.

To this end, as mentioned above, a first tubular end piece 26 carrying at least one annular sealing gasket 29 is mounted on the first longitudinal end 18a of the internal tube 18. The gasket 29 is configured to cooperate with second housing 22c of first block 22 to provide a seal. A second tubular end piece 26 carrying at least one annular sealing gasket 29 is mounted on the second longitudinal end 18b of the internal tube 18. The gasket 29 is configured to cooperate with the second housing 24c of the second block 24 to provide a seal.

In the example shown, the first and second end pieces 26 each carry two annular sealing gaskets 29 (FIG. 7).

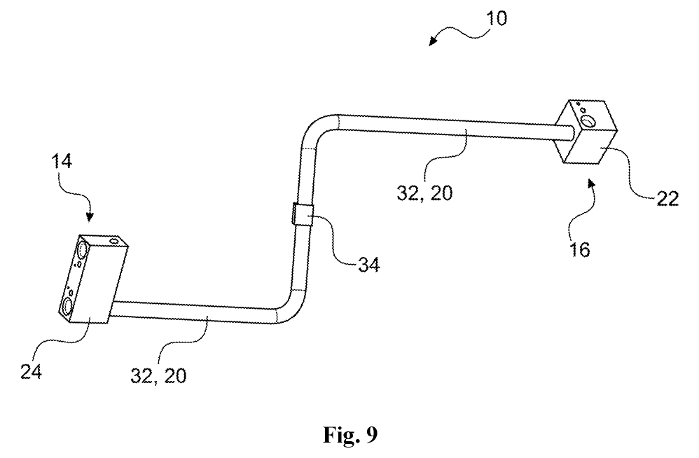

The method may comprise, after step d), a step e) of shaping the tubing 12 by bending and plastic deformation of said tubing, to give it a shape such as illustrated in FIG. 9, for example.

The disclosure allows a sealed fluid connection to be made between the tubing 12 and the connectors 14, 16, without blind welding, while limiting the size of the exchanger 10.

1. A method for assembling a heat exchanger with coaxial tubing, in particular for an air-conditioning circuit of a vehicle, the exchanger comprising:
a coaxial tubing comprising two coaxial tubes, an internal tube and an external tube respectively, the external tube defining, around the internal tube, a first annular channel (C1) for circulation of a first fluid, and the internal tube internally defining a second channel (C2) for circulation of a second fluid, the tubes being independent and one of the tubes comprising projections bearing on the other of the tubes in order to keep them at a distance from one another,
a first fluid connector formed by a first block located at a first longitudinal end of the tubing, the first block comprising a first housing for receiving a first longitudinal end of the external tube and a first port in fluid communication with said first housing, the first block comprising a second housing, coaxial with the first housing, for receiving a first longitudinal end of the internal tube and a second port in fluid communication with said second port, and
a second fluid connector formed by a second block located at a second longitudinal end of the tubing, opposite the first longitudinal end, the second block comprising a first housing for receiving a second longitudinal end of the external tube, and a first port in fluid communication with said first housing, the second block comprising a second housing, coaxial with the first housing, for receiving a second longitudinal end of the internal tube and a second port in fluid communication with said second port,
wherein the internal tube is formed in a single piece and the external tube is formed by two consecutive sections, the method comprises the following successive steps:
a) the first longitudinal end of the external tube is engaged in the first housing of the first block and this first longitudinal end is fixed to the first block, this first longitudinal end being located on a first of the sections of the external tube, and the second longitudinal end of the external tube is engaged in the first housing of the second block and this second longitudinal end is fixed to the second block, this second longitudinal end being located on a second of the sections of the external tube,
b) the internal tube is engaged in the first section, from a free longitudinal end of this first section, opposite the first block, then the internal tube is made to slide in the first section until the first longitudinal end of the internal tube engages in the second housing of the first block,
c) the internal tube is engaged in the second section, from a free longitudinal end of this second section, opposite the second block, then the internal tube is made to slide in the second section until the second longitudinal end of the internal tube engages in the second housing of the second block, and
d) the first and second sections of the external tube are secured to each other by means of their respective free longitudinal ends.

2. The method according to claim 1, wherein, in step d), the first and second sections of the external tube are secured to each other by means of a connection sleeve which connects their respective free longitudinal ends.

3. The method according to claim 2, wherein the connection sleeve is mounted on the free longitudinal end of the first section, before step a), or before step b).

4. The method according to claim 2, wherein the connection sleeve is mounted on the free longitudinal end of the second section, before step a), or before step b), or before step c).

5. The method according to claim 2, wherein the connection sleeve is fixed to the free longitudinal ends of the first and second sections by brazing, welding or gluing.

6. The method according to claim 1, wherein, in step d), the first and second sections of the external tube are secured to each other by welding, brazing or direct bonding of these sections.

7. The method according to claim 1, wherein, in step d), the first and second sections of the external tube are secured to each other by deforming the free longitudinal end of one of the sections to form a female part, or respectively a male part, by inserting the free longitudinal end of the other of the sections by male-female engagement on or in the deformed free longitudinal end, and by welding, brazing or gluing these free ends.

8. The method according to claim 1, wherein the first and second longitudinal ends of the external tube are fixed respectively to the first and second blocks by welding, brazing or gluing.

9. The method according to claim 1, wherein the first and second longitudinal ends of the internal tube are not fixed respectively to the first and second blocks by welding, brazing or gluing.

10. The method according to claim 1, wherein a first tubular end piece carrying at least one annular sealing gasket is located at the first longitudinal end of the internal tube, said at least one gasket being configured to cooperate with said second housing of the first block to provide a seal, and a second tubular end piece carrying at least one annular sealing gasket is located at the second longitudinal end of the internal tube, said at least one gasket being configured to cooperate with said second housing of the second block to provide a seal.

11. The method according to claim 8, wherein each of the first and second tubular end pieces is mounted on or in the corresponding longitudinal end, and fixed to that end by welding, brazing or bonding.

12. The method according to claim 8, wherein each of the first and second tubular end pieces is formed directly on the corresponding longitudinal end, and is therefore formed in one piece with the internal tube.

13. The method according to claim 10, wherein the first and second end pieces each carry two annular sealing gaskets.

14. The method according to claim 1, wherein it comprises, after step d), a step e) of shaping the tubing by bending and plastic deformation of this tubing.

15. A heat exchanger with coaxial tubing, in particular for an air-conditioning circuit of a vehicle, the exchanger being obtained by the method according to claim 1, the heat exchanger comprising:
a coaxial tubing comprising two coaxial tubes, an internal tube and an external tube respectively, the external tube defining, around the internal tube, a first annular channel (C1) for circulation of a first fluid, and the internal tube internally defining a second channel (C2) for circulation of a second fluid, the tubes being independent and one of the tubes comprising projections bearing on the other of the tubes in order to keep them at a distance from one another,
a first fluid connector formed by a first block located at a first longitudinal end of the tubing, the first block comprising a first housing for receiving a first longitudinal end of the external tube and a first port in fluid communication with said first housing, the first block comprising a second housing, coaxial with the first housing, for receiving a first longitudinal end of the internal tube and a second port in fluid communication with said second port, and
a second fluid connector formed by a second block located at a second longitudinal end of the tubing, opposite the first longitudinal end, the second block comprising a first housing for receiving a second longitudinal end of the external tube, and a first port in fluid communication with said first housing, the second block comprising a second housing, coaxial with the first housing, for receiving a second longitudinal end of the internal tube and a second port in fluid communication with said second port,
wherein the internal tube is formed in a single piece and the external tube is formed by two consecutive sections,
wherein the internal tube has its two longitudinal ends mounted respectively in the second housings of the first and second blocks without these longitudinal ends being fixed to the first and second blocks by welding, brazing or gluing,
wherein the external tube has its two longitudinal ends mounted respectively in the first housings of the first and second blocks and fixed by welding, brazing or gluing to the first and second blocks, and
wherein the longitudinal ends of the first and second sections of the external tube, opposite the first and second blocks respectively, are secured to each other, in particular by a connecting sleeve fixed by welding, brazing or gluing to these longitudinal ends of the first and second sections.
